(19) United States
(12) Patent Application Publication
(10) Pub. No.: US 2002/0142268 A1
(43) Pub. Date: Oct. 3, 2002

(54) Method to transmit astrological information on a locator enabled mobile device

(75) Inventors: Rabindranath Dutta, Austin, TX (US); David Bruce Kumhyr, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/820,503

(22) Filed: Mar. 29, 2001

(51) Int. Cl. G09B 19/00

(52) U.S. Cl. 434/106

(57) ABSTRACT

A method, system and computer readable instructions for determining astrological information for an operator of a mobile computing device is provided. Geographic position data of the operator is obtained and reported by an automatic location positioning system. Personal characteristics of the operator are correlated with the geographic position data. Astrological information is calculated based on the personal characteristics of the operator and the geographic position data.

### BACKGROUND OF THE INVENTION

1. Technical Field

This invention relates generally to a method for displaying horoscope content to a plurality of viewers and, more particularly, to a method for providing different horoscope content to different operators based on operator characteristics and operator location.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

A horoscope is a map that appears as a two dimensional chart showing the position of the sun, the moon and planets as the precise moment of a person's birth. In the natal horoscope, the planets are frozen at the moment of a person's birth. This type of horoscope is known as a a birth chart or natal chart. An interpretation of the birth positions of the planets exposes the “hand” that has been “dealt” a person while alive. A horoscope can never show a person how to play this hand, however the horoscope does reflect natural inclinations that a person has to live with, lessons a person has learned, issues a person must face and problems a person must solve. A horoscope may be thought of an abstract formula showing energies that a person has been given. The use a person makes of these energies depends on the individual. The art of creating a horoscope, otherwise known as astrology, can provide incredible keys to understanding, however it does not provide clear and simplistic answers to any problems a person may be dealing with. Obtaining information about a horoscope may allow a person some insights and understandings of the reasons why the person behaves in a particular way.

Horoscopes are very popular with a large section of the public, throughout the United States and abroad. Presently, horoscopes are available on a daily basis in most newspapers, published in numerous books, and are available on numerous sites on the Internet or the world wide web (WWW). To access a particular horoscope on the Internet, one needs either a personal computer or a notebook computer with some type of dial up or high speed connection. However, a horoscope may be very location specific in that the location of a person at a particular point in time may designate the person's horoscope at that instant. A personal computer, for the most part, is installed and remains in a dedicated location. Therefore, any information regarding a horoscope may be outdated and difficult to access on an as needed basis. Notebook computers possess some of the same limitations; while more portable, a notebook computer does require a space to set up and a connection to access the Internet. However, current technology has provided smaller hand-held wireless devices which may be used without the limitations inherent with a personal computer or notebook computer while allowing instant access to the Internet at the whim of the user and providing quick and up to date information regarding a person's horoscope.

Therefore, it would be advantageous to provide a method, system and apparatus that provides reliable and quick access to horoscopes for a user based on the user's location at the moment using a portable hand held wireless Internet compatible device.

### SUMMARY OF THE INVENTION

The present invention provides a method, system and computer readable instructions for determining astrological information for a user of a mobile computing device. Geographic position data of the device is obtained and reported by an automatic location positioning system. Personal characteristics of the operator are correlated with the geographic position data. Astrological information is calculated based on the personal characteristics of the operator and the geographic position data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a computing system is depicted in accordance with a preferred embodiment of the present invention;

FIG. 2 is a pictorial representation of a networked data processing system in which the present invention may be implemented;

FIG. 3 is a block diagram depicts a data processing system, which may be implemented as a server, in accordance with a preferred embodiment of the present invention;

FIG. 4A depicts an exemplary display of astrological data for a user for a first location in accordance with a preferred embodiment of the present invention;

FIG. 4B depicts an exemplary display of astrological data for a user for a second location in accordance with a preferred embodiment of the present invention;

FIG. 4C depicts an exemplary display of astrological data for a user for a third location in accordance with a preferred embodiment of the present invention; and

FIG. 5 is an exemplary flowchart illustrating gathering and dissemination of astrological information using an automatic location positioning system in accordance with a preferred embodiment of the present invention.

### DETAILED DESCRIPTION OF THE PREFERRED EMBODIMENT

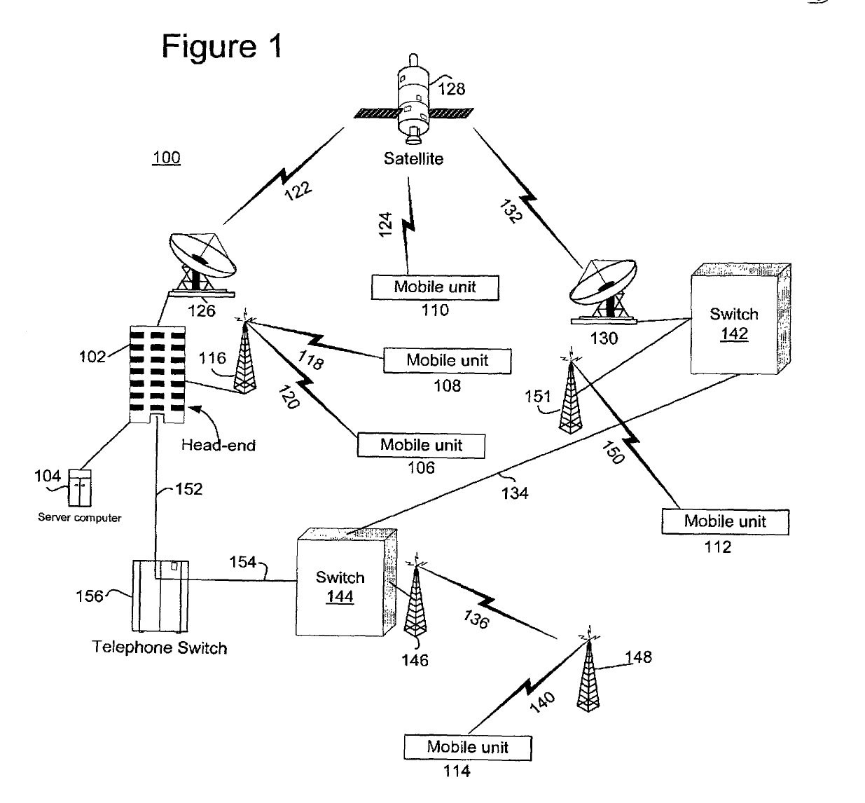

With reference now to the figures and in particular with reference to FIG. 1, a diagram of a computing system 100 is depicted in accordance with a preferred embodiment of the present invention. In this example, head-end 102 is connected to a server computer 104, which is employed to collect data from various automotive computing platforms that may be present within computing system 100. In particular, server computer 104 may communicate with various mobile units 106-114. These mobile units each contain a computing platform, which may communicate with server 104. In this example, communications between various mobile units may be accomplished through a cellular phone system or through an Iridium satellite phone system or other wireless systems.

Communications between server computer 104 and mobile units 106-114 is accomplished in a number of different ways in this example. For example, radio tower 116 provides communications links 118 and 120 to mobile units 108 and 106 respectively. Communications links 118 and 120 are radio frequency communications links generated between radio tower 116 and antennas located at mobile units 106 and 108. In addition, server 104 may communicate with mobile unit 110 through communications links 122 and 124. Communications link 122 is established between satellite dish 126 and satellite switch 128 with communications link 124 being established between satellite 128 and mobile unit 110. Communications links 122 and 124 are radio frequency based links generated by signals sent to satellite switch 128 from satellite dish 126 and from satellite switch 128 to mobile unit 110. In this example, radio tower 116 and satellite dish 126 are connected to head-end 102 and provide for transmissions originating from or passing through head-end 102.

Further, signals may be sent from satellite switch 128 to satellite dish 130 via communications link 132. From satellite dish 130, information may be sent to mobile unit 114 through communications link 134, 136, and 140. Communications link 134 in this example is a link between switch 142 and switch 144. In this manner, a path may be established from server computer 104 to mobile unit 114 to create a path containing communications links 122, 132, 134, 136, and 140. Communications link 134 is a physical link, which may be for example, coaxial cable, fiber optic cable, or a combination of the two. Each switch also has a “link”, also called a “path” within the switch for writing data through the switch. An “input link” is the input or source portion of the link associated with the input into the switch, and an “output link” is the output or destination portion of the link associated with the output from the switch. Communications link 136 is established between radio towers 146 and 148. Radio tower 146 is connected to switch 144 in FIG. 1. Communications link 140 is established between radio tower 148 and mobile unit 114. Communications with mobile unit 112 may be established through a path containing communications links 122, 132, and 150. Communications link 150 is established between radio tower 151 and mobile unit 112. In this example, satellite dish 130 and radio tower 151 are connected to switch 142.

In addition, server computer 104 may use an alternate path to communicate with mobile unit 114. For example, a path through communications links 152, 154, 136, and 140 may be employed to communicate with mobile unit 114. Links 152 and 154 are physical links in this example. Communications link 152 is established between head-end 102 and switch 156, while communications link 154 is established between switch 156 and switch 144. In this manner, data signals, such as multi-media data, which may include video, graphics, voice, and text may be sent between server computer 104 and mobile units 106-114.

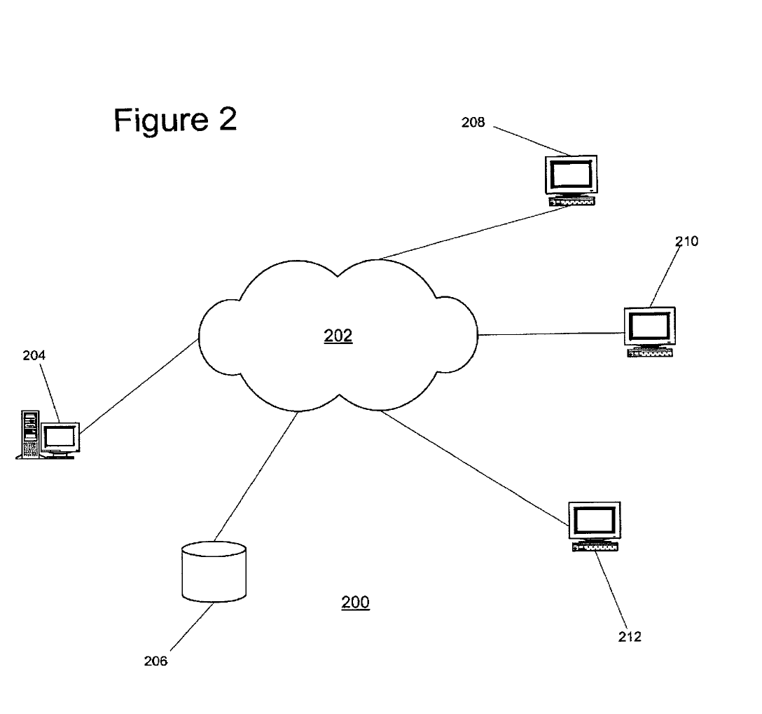

FIG. 2 is a pictorial representation of a networked data processing system in which the present invention may be implemented. Networked data processing system 200 is a network of computers in which the present invention may be implemented. Networked data processing system 200 contains a network 202, which is the medium used to provide communications links between various devices and computers connected together within networked data processing system 200. Network 202 may include wireline connections, such as copper wire or fiber optic cables, and wireless connections, such as cellular telephone connections. Also, the connections for network 202 may be either permanent, such as with a dedicated line, and/or temporary, such as connections made through dial up telephone connections.

In the depicted example, a server 204 is connected to network 202 along with storage unit 206. In addition, clients 208, 210, and 212 also are connected to network 202. These clients 208, 210, and 212 may be, for example, personal computers, mobile devices such as cellular phones, internet enabled personal digital assistants (PDAs) or network computers. For purposes of this application, a network computer is any computer, coupled to a network, which receives a program or other application from another computer coupled to the network. In the depicted example, server 204 provides data and applications to clients 208-112. Clients 208, 210, and 212 are clients to server 204. In a multi-tier networked environment, networked applications are provided in which a portion of the application is located on a server, such as server 204 and another portion of the application is located on a client, such as client 208. In this implementation, the client is considered a first tier system while the server is considered a second tier system.

Networked data processing system 200 may include additional servers, clients, and other devices not shown. In the depicted example, networked data processing system 200 is the Internet with network 202 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, networked data processing system 200 also may be implemented as an number of different types of networks, such as, for example, an intranet or a local area network. Popular communication protocols may be hypertext transfer protocol or wireless applications housed in the network.

Mobile units 106-114 in FIG. 1 may contain a browser for locating sites on the Internet, an audio unit for announcing data either received by or contained in mobile units 106-114 and, for example, a GPS unit for locating the position of a mobile unit. Mobile units 106-114 may also contain an application which may be, for example, Internet communications software, for enabling communications between, for example, the Internet and a mobile unit. The browser may receive position data of the mobile unit along with personal characteristic data of the user for which astrological information is to be determined. The personal characteristic data of the user may be, for example, input via the mobile unit, stored within the mobile unit, or stored on a server. A server, such as server 204, may contain an application, such as astrological computation software to compute astrological information for a user based on position data and personal characteristics. The computed astrological information may then be sent to a web server which then transmits the computed astrological information via the Internet communications software which then transmits the computed astrological information to a mobile unit, such as, for example, one or more mobile units 106-114.

FIG. 2 is intended as an example, and not as an architectural limitation for the processes of the present invention. For example, network 202 may use other hardware devices, such as, plotters, optical scanners, and the like in addition or in place of the hardware depicted in FIG. 2.

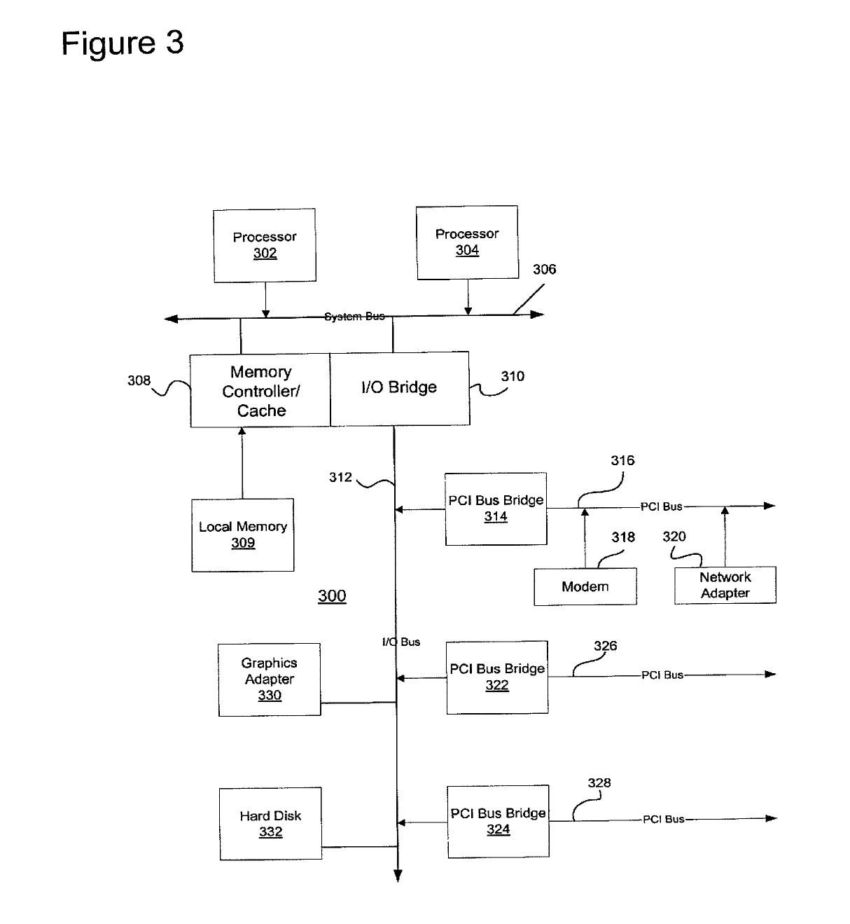

FIG. 3 is a block diagram depicts a data processing system, which may be implemented as a server, such as server computer 104 in FIG. 1, in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems 318-320 may be connected to PCI bus 316. Typical PCI bus implementations will support four PCI expansion slots or add-in connectors. Communications links to transmitters in FIG. 1 may be provided through modem 318 and network adapter 220 connected to PCI local bus 316 through add-in boards.

Additional PCI bus bridges 322 and 324 provide interfaces for additional PCI buses 326 and 328, from which additional modems or network adapters may be supported. In this manner, server 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as an optical disk drive and the like, also may be used in addition to or in place of the hardware depicted. The depicted example is not meant to imply architectural limitations with respect to the present invention.

The data processing system depicted in FIG. 3 may be, for example, an IBM eServer pSeries, a product of International Business Machines Corporation in Armonk, N.Y., running the Advanced Interactive Executive (AIX) operating system or the Linux operating systems.

The present invention provides a method to display horoscope information using an automatic location positioning system on a location enabled mobile device. It will be assumed for purposes of the description of the present invention that the invention is implemented using a global positioning system (GPS) or one of the aforementioned telephone systems, although it should be appreciated that the present invention is not limited to such an embodiment. A user may be either an operator of the device or another person who's location and personal characteristics, such as, for example date, time and place are birth are entered. A user may enter the date, time and place of birth of either the user or someone other than the user.

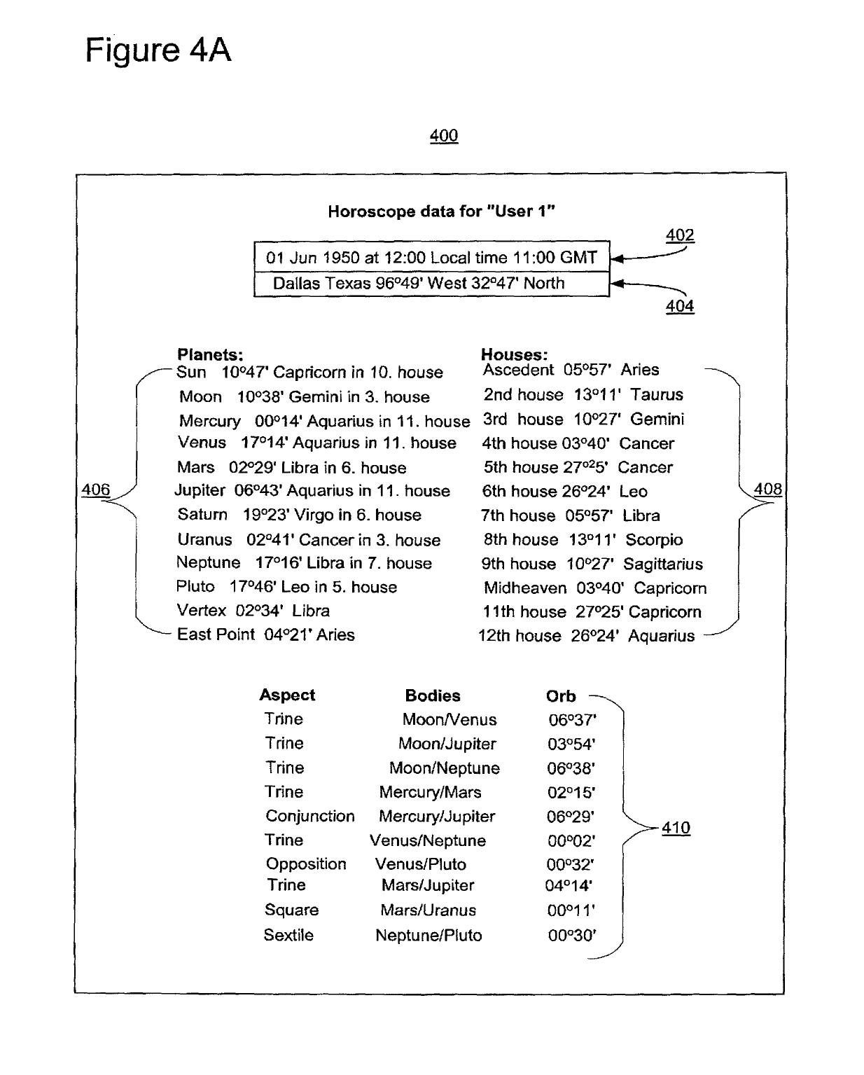

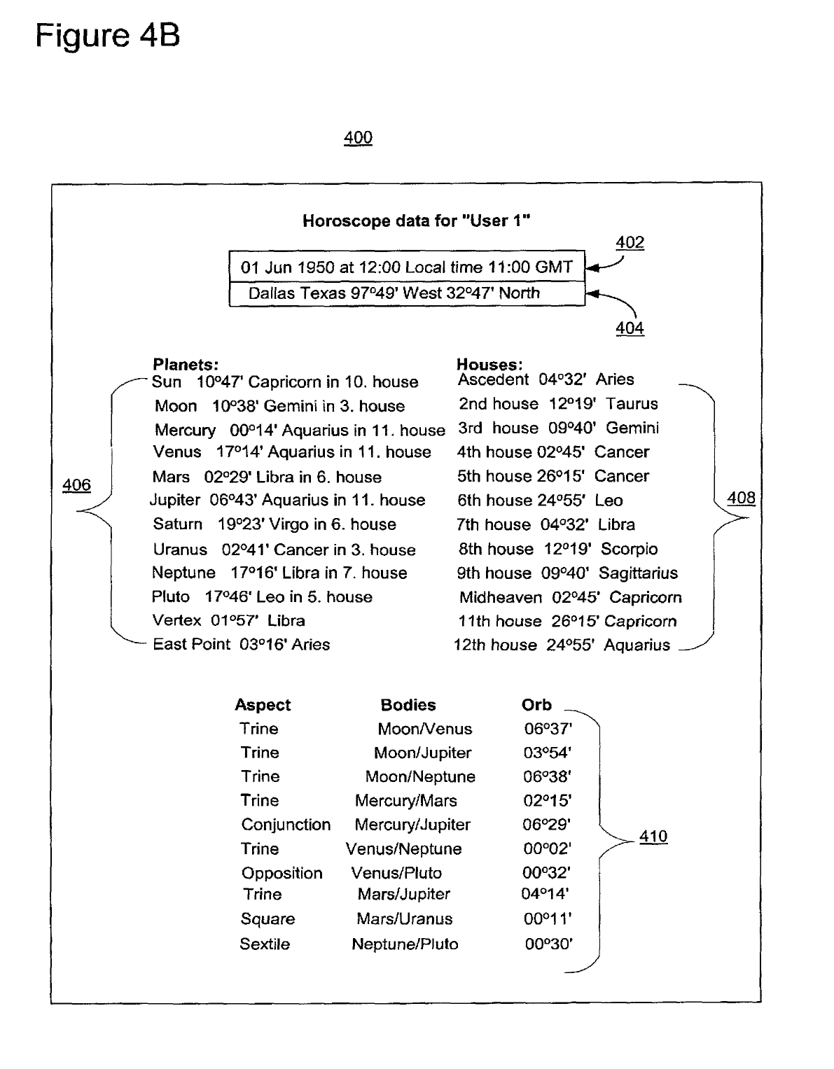

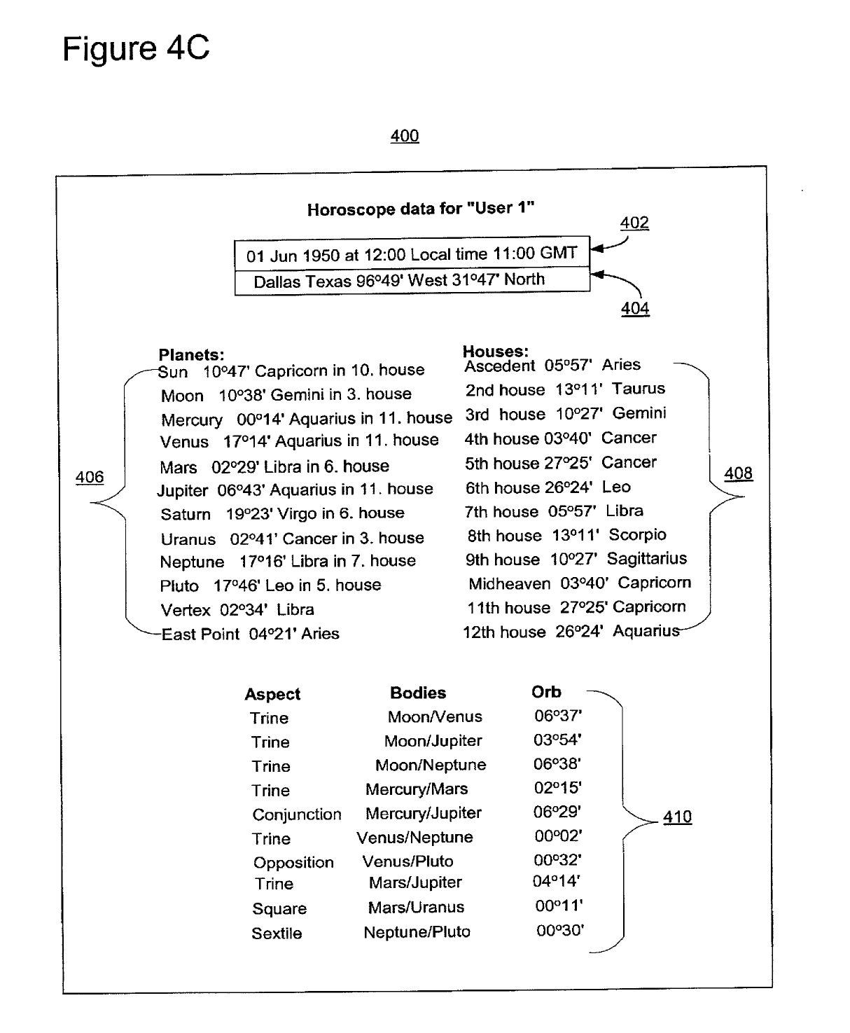

FIG. 4A depicts an exemplary display of astrological data for a user for a first location in accordance with a preferred embodiment of the present invention. Horoscope data display 400 illustrates a possible format in which astrological data may be presented although it is appreciated that other alternate formats may also be used either in lieu of horoscope data display 400 or in addition to horoscope data display 400. In this example, horoscope data display 400 consists of user data field 402 and user location field 404. In user data field 402 may be the date of the user's birth along with the time of the user's birth. The time of the user's birth may be alternately displayed at local time and Greenwich Meridian time (GMT). User location field 404 may consist of the user's present location which may be expressed alternately as a named location anywhere in the world and using applicable longitudinal and latitudinal coordinates. One drawback of using only a named location anywhere in the world is that the exact location of the user may not be known and, therefore, a astronomical reading based only on a named location may not reflect a true relationship to the user's actual location. The present invention addresses this drawback and locates the user using the longitudinal and latitudinal coordinates, thereby pinpointing the exact location of the user at a certain point in time.

In this example, the user is born on Jun. 1, 1950 at 12:00 local time or 11:00 GMT. The present location of the user is in Dallas, Tex. at an exact location of 96°49′ West and 32°47′ North. Horoscope data display 400 also includes categories of planets 406, houses 408 and aspect/bodies/orbit 410 in which astronomical features of the user may be determined. For example planets 406 indicates that the sun is at 10°47′ and is in the 10th house of Capricorn. Additionally, planets 406 indicates that Saturn is at 19°23′ in the 6th house of Virgo. It should be noted at this point in planets 406 that Vertex is at 2°34′ in Libra and East Point is 4°21′ in Aries. Additionally, houses 408 of the zodiacs is shown in horoscope data display 400. For example, the 2nd house is at 13°11′ of Taurus and the 12th house is at 26°24′ of Aquarius.

Finally, in horoscope data display 400 is aspect/bodies/orbit field 410. For example, Mercury and Jupiter are in conjunction with each other at an orbit of 6°29′. Venus and Pluto are in opposition to each other at 0°32′. The Moon is in trine with Venus, Jupiter and Neptune at 6°37′, 3°54′ and 6°38′, respectively. Trine is the aspect of two bodies distant from each other by 120 degrees. Neptune is in sextile with Pluto at 0°30′. Sextile is the aspect of two bodies which have a distance of 60 degrees.

FIG. 4B depicts an exemplary display of astrological data for a user for a second location in accordance with a preferred embodiment of the present invention. In this example, user data for horoscope data display 400 in FIG. 4A was held constant except that the current location of the user was varied by 1 degree west. Therefore, as indicated in user location field 404 is that the user is still in Dallas, Tex. but is now located at 97°49′ West and 32°47′ North. As stated above, the change in location of the user may be determined by either using an automatic location positioning system, such as for example, GPS, by user input, or by other locator means. Of particular note in FIG. 4B is the fact that in planets 406, the sun, the moon and the planets remain in the same houses of the zodiac as in FIG. 4A. However, the vertex within planets 406 is now at 1°57′ in Libra and the east point is at 3°16′ in Aries as opposed to 2°34′ in Libra and 4°21′ in Aries, respectively, in FIG. 4A. Although in houses 408 the houses remain in the same astrological signs as in FIG. 4A, the position of the houses within each sign has changed. For example, Ascedent is now at 4°32′ in Aries as opposed to 5°57′ in Aries in FIG. 4A. In addition, the 2nd house, 3rd house, 4th house, 5th house, etc. remain in their appropriate astrological sign, but similarly their position within these astrological signs have also changed do to the fact that the user has altered position by, in this example, 1 degree to the west.

FIG. 4C depicts an exemplary display of astrological data for a user for a third location in accordance with a preferred embodiment of the present invention. In this example, user data for horoscope data display 400 in FIG. 4A was held constant except that the current location of the user was varied by 1 degree south. Therefore, as indicated in user location field 404 is that the user is still in Dallas, Tex. but is now located at 96°49′ West and 31°47! North. As stated above, the change in location of the user may be determined by either using an automatic location positioning system, such as for example, GPS, or by user input. As with FIG. 4B in planets 406, the sun, the moon and the planets remain in the same houses of the zodiac as in FIG. 4A. However, the vertex within planets 406 is now at 2°34′ in Libra and the east point is at 4°21′ in Aries as opposed to 1°57′ in Libra and 3°16′ in Aries, respectively, in FIG. 4B. Although in houses 408 the houses remain in the same astrological signs as in FIGS. 4A and 4B, the position of the houses within each sign has again changed. For example, Ascedent is now at 5°57′ in Aries as opposed to 4°32′ in Aries in FIG. 4B. In addition, the 2nd house, 3rd house, 4th house, 5th house, etc. remain in their appropriate astrological sign, but similarly their position within these astrological signs have also changed do to the fact that the user has altered position by, in this example, 1 degree to the south.

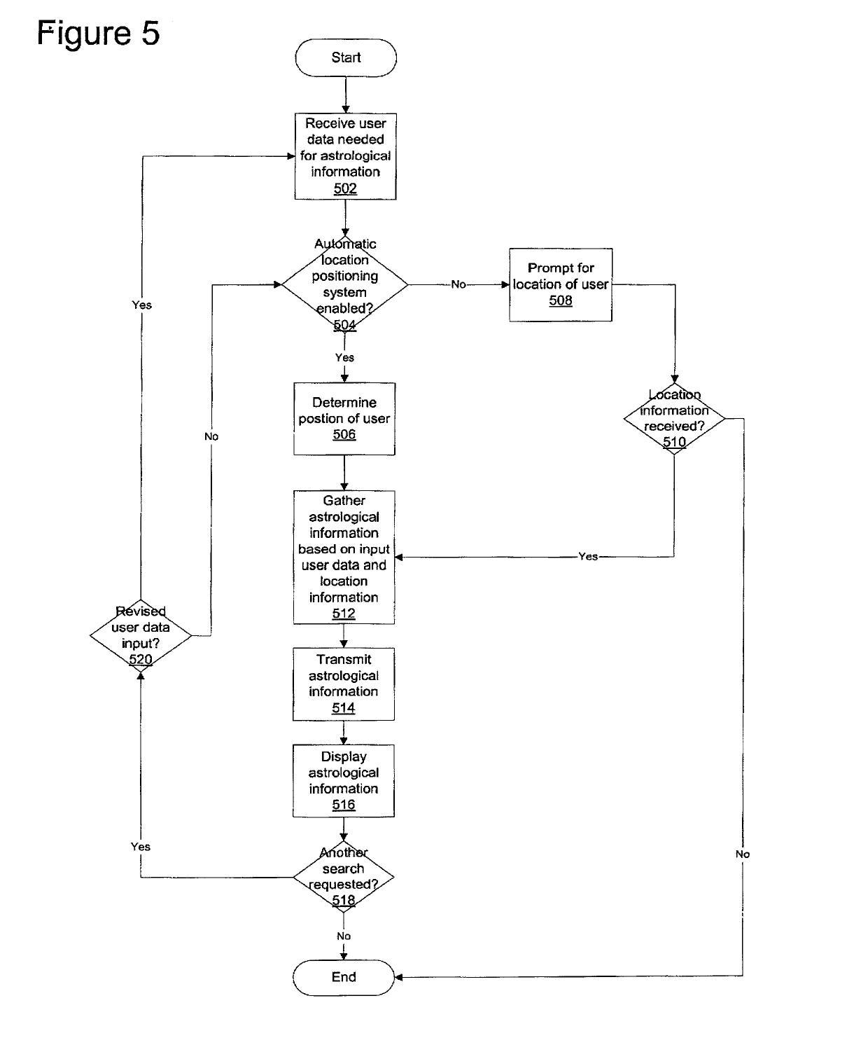

FIG. 5 is an exemplary flowchart illustrating gathering and dissemination of astrological information using an automatic location positioning system in accordance with a preferred embodiment of the present invention. In this example, the operation begins by receiving user data needed to supply astrological information (step 502). This information may consist of date of birth, place of birth, time of birth, and the like. Then a determination is made as to whether or not an automatic location positioning system is enabled (step 504). If an automatic location positioning system is not enabled (step 504:NO), a user is prompted for location information (step 508). Then a determination is made as to whether or not the location information is received (step 510). If the location information is not received (step 510:NO), the operation terminates. If the location information is received (step 510:YES), the operation continues to step 512 in which astrological information is gathered based on input user data and location information. The computation of the position of the planets, houses, etc. is well known in the prior art.

Returning to step 504, if an automatic location positioning system is enabled (step 504:YES), the location of the user is determined. The location of the user may be determined by using, for example, a global positioning system. Then astrological information is gathered based on received user data and the location information (step 512). The astrological information is transmitted (step 514). The astrological information may be transmitted to a personal digital assistant (PDA), a notebook computer, hand-held computer and the like. The astrological information is then displayed (step 516). In an alternate embodiment, the astrological data may be conveyed to the user audibly. Then a determination is made as to whether or not another astrological search is to be performed (step 518). If another astrological search is not to be performed (step 518:NO), the operation terminates. If another astrological search is to be performed (step 518:YES), a determination is made as to whether or not revised user data has been input (step 520). If revised user data has not been input (step 520:NO), the operation returns to step 504 in which a determination is made as to whether or not an automatic location positioning system is enabled. If revised user data has been input (step 520:YES), the operation returns to step 502 in which user data needed for astrological information is received.

Therefore, the present invention provides a method, system and apparatus that provides reliable and quick access to horoscopes for a user based on the user's location at the moment using a portable hand held wireless Internet compatible device. A user may be either an operator of the device or another person who's location and personal characteristics, such as, for example date, time and place are birth are entered. A user may enter the date, time and place of birth of either the user or someone other than the user. The automatic location positioning system will automatically determine the location of the user and retrieve astrological data for the user based on the entered information as well as the location of the user. The astrological data will be transmitted to the portable hand held wireless Internet compatible device. The astrological data may be displayed upon the device or may be conveyed to the user in an audible fashion.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally, regardless of the particular type of signal bearing media actually used to carry out the distribution. Examples of computer readable media include recordable-type media such as a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. For example, the astrological information is shown to be delivered to a client device via a server based on a location of a user. However, the astrological information may be contained in the mobile device without the use of a server. Furthermore, the astrological information may be processed further, for example, to deliver the user's fortune, to present the relationship compatability of the user with various signs of the zodiac, to predict a user's fame and fortune aspects, and the like. In addition, a GPS was shown to be the automatic location positioning system, but the present invention is not limited to a GPS system. For instance, other means of locating a user may be used within the spirit and scope of the invention. For example, an automatic location positioning system used in tracking mobile phone users may be used with the present invention in place of the GPS. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining astrological information for a user of a mobile computing device, comprising the steps of:
obtaining geographic position data of the user as reported by an automatic location positioning system;
correlating personal characteristics of the user with the geographic position data; and
calculating the astrological information based on the personal characteristics of the user and the geographic position data.

2. The method as recited in claim 1, wherein the geographic position data is reported by a Global Positioning System (GPS).

3. The method as recited in claim 1, further comprising:
transmitting the astrological information; and
presenting the astrological information on the mobile computing device.

4. The method as recited in claim 3, wherein the astrological information is presented on the mobile device by at least one of a visual presentation and an audible presentation.

5. The method as recited in claim 1, wherein the mobile computing device is one of a personal digital assistant (PDA), a notebook computer, a hand-held computer and a cellular telephone.

6. The method as recited in claim 1, wherein the personal characteristics of the user include at least one of a birth date, a time of birth and a location of birth.

7. The method as recited in claim 1, wherein the astrological information is at least one of planet information, zodiac information, and aspect information.

8. A computer program product, in a computer-readable medium, for determining astrological information for a user of a mobile computing device, comprising:
instructions for obtaining geographic position data of the user as reported by an automatic location positioning system;
instructions for correlating personal characteristics of the user with the geographic position data; and
instructions for calculating the astrological information based on the personal characteristics of the user and the geographic position data.

9. The computer program product as recited in claim 8, wherein the geographic position data is reported by a Global Positioning System (GPS).

10. The computer program product as recited in claim 8, further comprising:
instructions for transmitting the astrological information; and
instructions for presenting the astrological information on the mobile computing device.

11. The computer program product as recited in claim 10, wherein the astrological information is presented on the mobile device by at least one of a visual presentation and an audible presentation.

12. The computer program product as recited in claim 8, wherein the mobile computing device is one of a personal digital assistant (PDA), a notebook computer, a hand-held computer, and a cellular telephone.

13. The computer program product as recited in claim 8, wherein the personal characteristics of the user include at least one of a birth date, a time of birth and a location of birth.

14. The computer program product as recited in claim 8, wherein the astrological information is at least one of planet information, zodiac information, and aspect information.

15. A system, comprising:
an automatic location positioning system;
a communications unit connected to the automatic location positioning system; and
a data processing system connected to the automatic location positioning system and the communications unit, wherein the data processing system obtains geographic position data of a user as reported by an automatic location positioning system from the communications unit, the data processing system correlates personal characteristics of the user with the geographic position data, and calculates the astrological information based on the personal characteristics of the user and the geographic position data.

16. The system as recited in claim 15, further comprising:
an output unit, wherein the communications unit transmits the astrological information and the output unit presents the astrological information on the mobile computing device.

17. The system in claim 16, wherein the astrological information is presented on the mobile device by at least one of a visual presentation and an audible presentation.

18. A data processing system for determining astrological information for a user of a mobile computing device, comprising:
obtaining means for obtaining geographic position data of the user as reported by an automatic location positioning system;
correlating means for correlating personal characteristics of the user with the geographic position data; and
calculating means for calculating the astrological information based on the personal characteristics of the user and the geographic position data.

19. The data processing system as recited in claim 18, wherein the geographic position data is reported by a Global Positioning System (GPS).

20. The data processing system as recited in claim 18, further comprising:
transmitting means for transmitting the astrological information; and
presenting means for presenting the astrological information on the mobile computing device.

21. The data processing system as recited in claim 20, wherein the astrological information is presented on the mobile device by at least one of a visual presentation and an audible presentation.

22. The data processing system as recited in claim 18, wherein the mobile computing device is one of a personal digital assistant (PDA), a notebook computer, a hand-held computer, and a cellular telephone.

23. The data processing system as recited in claim 18, wherein the personal characteristics of the user include at least one of a birth date, a time of birth and a location of birth.

24. The data processing system as recited in claim 18, wherein the astrological information is at least one of planet information, zodiac information, and aspect information.
